(19) United States
(12) Patent Application Publication
(10) Pub. No.: US 2021/0171403 A1
(43) Pub. Date: Jun. 10, 2021

(54) WEAR-RESISTANT MATERIAL, LOCALLY-REINFORCED LIGHT METAL MATRIX COMPOSITES AND MANUFACTURING METHOD

(71) Applicant: NINGBO HIGHRISE NEW MATERIAL CO.,LTD., Zhejiang (CN)

(72) Inventors: Lin QI, Zhejiang (CN); Pixiang QI, Zhejiang (CN)

(73) Assignee: NINGBO HIGHRISE NEW MATERIAL CO.,LTD., Zhejiang (CN)

(21) Appl. No.: 16/071,078

(22) PCT Filed: Nov. 27, 2017
(86) PCT No.: PCT/CN2017/000702

§ 371 Date: Jul. 19, 2018

(30) Foreign Application Priority Data
Nov. 13, 2017 (CN) 201711113030.3

(51) Int. Cl. C04B 35/80; B22D 18/02; C04B 33/135; B22C 9/02; B22F 7/00; B22D 19/02

(52) U.S. Cl. CPC C04B 35/80; C04B 2235/602; C04B 33/1352; B22C 9/02; B22F 7/006; B22D 19/02; C04B 2235/3826; C04B 2235/5228; C04B 2235/5232; C04B 2201/50; C04B 2235/5224; C04B 2235/405; C04B 2235/407; C04B 2235/5264; C04B 2235/606; B22D 18/02

(57) ABSTRACT

A composition of the wear-resistant material of the present invention includes high-temperature resistant skeleton metal materials, ceramic fiber materials and ceramic particle materials with the mass ratio of (10-60):(1-30):(10-70). The high-temperature resistant skeleton metal materials are foam metal or high-temperature resistant metal fibers. The wear-resistant material is good in wear-resistance, high in tenacity, suitable for occasions with high requirements for wear-resistance and tenacity and capable of being locally attached to the surface of the light metal alloy matrix to improve the wear-resistance and tenacity of the light metal alloy matrix under high temperature conditions. The locally-reinforced light metal matrix composites of the present invention are the light metal alloy matrix locally-reinforced through the wear-resistant material. A manufacturing method of the locally-reinforced light metal matrix composites of the present invention is to metallurgically bond the wear-resistant layer with the light metal alloy matrix is through the squeeze casting technique.

### BACKGROUND

### Technical Field

The invention relates to the technical field of wear-resistant materials and locally-reinforced metal matrix composites, in particular to a wear-resistant material, a light metal matrix composites locally-reinforced through the wear-resistant material, and a manufacturing method of the light metal matrix composites.

### Description of Related Art

Wear-resistant materials are important base materials in industrial production and closely related to modern production and life. The most common wear-resistant mechanisms in daily life are brake drums and brake discs of automobiles. The brake drums and the brake discs are key safety auto parts of automobiles, used for frictional braking and required to have excellent wear-resistance and comprehensive mechanical performance. In the driving process, reliable braking of the brake drums or the brake discs is very important, and if braking fails in emergency circumstances, safety accidents can be caused, and even car crashes can be caused. For this reason, the brake drums and the brake discs are extremely important safety auto parts. Most automotive brake drums and brake discs in China and foreign countries are always integrally through cast iron and have good wear-resistance and mechanical performance, the casting technique for the cast iron brake drums and brake discs is mature, and the cast iron brake drums and brake discs can be provided with complex ventilation holes, and are in low price and suitable for mass production. However, the cast iron brake drums and brake discs have the following defects. Firstly, the density of cast iron is high and reaches about 7.3 g/cm³, thus the cast iron brake drums and brake discs are heavy; as the weight of brake drums and brake discs belong to the unsprung weight , corresponding to three to five times of the sprung weight, oil consumption of the vehicle will be increased undoubtedly, and the maneuverability of vehicles is reduced; and relevant parts are difficult to assemble, disassemble and maintain. Secondly, heat conductivity of cast iron is poor, frictional heat generated in the braking process is dissipated slowly, and failures of brake systems are likely to be caused due to excessive temperature rise. Thirdly, the brake drums and brake discs of the cast iron are generally formed through sand casting, the dimensional accuracy and roughness of surface of the castings are poor, the shrinkage and porosity of the casting are difficult to control, labor intensity for casting production is high, and pollution to the environment is severe.

### SUMMARY

Firstly, the invention provides a wear-resistant material.

Secondly, the invention provides a light metal matrix composites locally-reinforced through the wear-resistant material.

Thirdly, the invention provides a manufacturing method of the light metal matrix composites.

According to the technical scheme adopted by the invention: a wear-resistant material is manufacturing from high-temperature resistant skeleton metal materials, ceramic fiber materials and ceramic particle materials, and the mass ratio of the high-temperature resistant skeleton metal materials, the ceramic fiber materials and the ceramic particle materials is (10-60):(1-30):(10-70). The high-temperature resistant skeleton metal material are foam metal or high-temperature resistant metal fibers. The high-temperature resistant metal fibers include one or more of iron-based alloy fibers, nickel-based alloy fibers, copper-based alloy fibers, stainless steel fibers, steel wool fibers, titanium-based alloy fibers and cobalt-based alloy fibers. The ceramic fiber materials include one or more of alumina fibers, alumina silicate fibers, silicon dioxide fibers, zirconium oxide fibers, silicon carbide fibers, graphite fibers and carbon fibers. The ceramic particle materials include one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles.

Preferably, auxiliary reinforcing particles, which are mixed in the ceramic particle materials, are graphite particles and/or steel slag particles. The steel slag particles are one or more of iron oxide particles, zinc oxide particles, calcium oxide particles, magnesium oxide particles, aluminum oxide particles and titanium oxide particles.

Preferably, the foam metal is foam copper, foam iron, foam nickel or foam iron-nickel.

Preferably, the diameter of the ceramic fiber materials is 5-15 μm, and the length of the ceramic fiber materials is 0.8-2.8 mm. The diameter of the high-temperature resistant metal fibers is 0.01-2 mm. The granularity of the ceramic particle materials is 5-200 μm, and the Mohs hardness of the ceramic particle materials is 5-9. The porosity of foam metal is 10-60 ppm.

A locally-reinforced light metal matrix composites includes a light metal alloy matrix and a wear-resistant layer locally attached to the surface of the light metal alloy matrix. The light metal alloy matrix is an aluminum alloy matrix or a magnesium alloy matrix. The wear-resistant layer is manufacturing from high-temperature resistant skeleton metal materials, ceramic fiber materials, ceramic particle materials, a low-temperature binding agent and a high-temperature binding agent, and the mass ratio of the high-temperature resistant skeleton metal materials the ceramic fiber materials, the ceramic particle materials, the low-temperature binding agent and the high-temperature binding agent is (10-60):(1-30):(10-70):(0.5-8):(0.5-10). The high-temperature resistant skeleton metal materials are foam metal or high-temperature resistant metal fibers. The high-temperature resistant metal fibers include one or more of iron-based alloy fibers, nickel-based alloy fibers, copper-based alloy fibers, stainless steel fibers, steel wool fibers, titanium-based alloy fibers and cobalt-based alloy fibers. The ceramic fiber materials include one or more of alumina fibers, alumina silicate fibers, silicon dioxide fibers, zirconium oxide fibers, silicon carbide fibers, graphite fibers and carbon fibers. The ceramic particle materials include one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles. The low-temperature binding agent is a carboxymethylcellulose aqueous solution with the concentration of 3-20%, and the high-temperature binding agent is a silica sol solution with the concentration of 10-60%.

Preferably, auxiliary reinforcing particles are mixed in the ceramic particle materials and are graphite particles and/or steel slag particles. The steel slag particles are one or more of iron oxide particles, zinc oxide particles, calcium oxide particles, magnesium oxide particles, aluminum oxide particles and titanium oxide particles.

Preferably, the foam metal is foam copper, foam iron, foam nickel or foam iron-nickel.

Preferably, the diameter of the ceramic fiber materials is 5-15 μm, and the length of the ceramic fiber materials is 0.8-2.8 mm. The diameter of the high-temperature resistant metal fibers is 0.01-2 mm. The granularity of the ceramic particle materials is 5-200 μm, and the Mohs hardness of the ceramic particle materials is 5-9. The porosity of foam metal is 10-60 ppm.

A manufacturing method of the locally-reinforced light metal matrix composites includes the following steps: by mass fraction, 1-30% of ceramic fiber materials, 10-70% of ceramic particle materials, 0.5-8% of the low-temperature binding agent, 0.5-10% of the high-temperature binding agent and a proper amount of water are evenly mixed to prepare ceramic slurry, a fixed amount of ceramic slurry is poured into a preform mold in which a high-temperature resistant skeleton metal is installed in advance, the pressure is increased to 20-30 MPa, and a semi-finished composites preform is manufacturing through dewatering and pressing; afterwards, the semi-finished composites preform is dried at the temperature 60-200° C. for 10-20 h and then sintered at the temperature of 700-1000° C. for 2.5-4 h to obtain a finished composites perform; and finally, the finished composites preform is attached to a light metal alloy matrix which manufacturing in advance by the squeeze casting technique, the wear-resistant layer preform and the light metal alloy matrix metallurgically bond, and thus the locally-reinforced light metal matrix composites is obtained.

Preferably, the manufacturing process of the high-temperature resistant skeleton metal includes the following steps: foam metal is machined into a sheet matched with the wear-resistant layer in shape and size, and thus the high-temperature resistant skeleton metal is obtained; or high-temperature resistant metal fibers are sorted, processed, woven and evenly spread in a skeleton preform mold and then compacted, and thus the high-temperature resistant skeleton metal is obtained.

Or, squeeze casting is replaced with environment-friendly sand mold casting, vacuum die casting, centrifugal casting, low pressure casting, differential pressure casting, metal mold casting, investment casting, lost foam casting or vacuum suction casting. Besides squeeze casting, the wear-resistant layer made of ceramic high-temperature composite reinforced materials can also metallurgically bond with an aluminum alloy brake disc body through other casting techniques such as environment-friendly sand mold casting, vacuum die casting, centrifugal casting, low pressure casting, differential pressure casting, metal mold casting, investment casting, lost foam casting and vacuum suction casting.

Compared with the prior art, the invention has the advantages:

1. The wear-resistant material of the invention is manufacturing from high-temperature resistant skeleton metal materials, ceramic fiber materials and ceramic particle materials with the mass ratio (10-60):(1-30):(10-20), thereby being good in wear-resistance, high in tenacity, suitable for occasions with high requirements for wear-resistance and tenacity and capable of being locally attached to the surface of the light metal alloy matrix to improve the wear-resistance and tenacity of the light metal alloy matrix under high temperature conditions.

2. As for the locally-reinforced light metal matrix composites of the invention, the light metal alloy matrix is locally-reinforced selectively through the wear-resistant material, and the wear-resistant layer is formed on the surface of the light metal alloy matrix to improve the wear-resistance and tenacity of the light metal alloy matrix under high temperature conditions; furthermore, as the specific gravity of the light metal alloy matrix is small, after the light metal alloy matrix is applied to brake drums or brake discs for automobiles, trains and the like and the wear-resistant layer is attached to the working surface of the light metal alloy matrix, the surface wear-resistance of the brake drums or brake discs manufacturing from the light metal alloy matrix can be improved by over four times compared with existing cast iron brake drums or brake discs, the weight can be reduced by over a half, and the heat conductivity of light metal alloy such as aluminum alloy and magnesium alloy is far better than that of cast iron so that the operating temperature of the brake drums (or the brake discs) can be decreased by about 100° C.; and meanwhile, as the weight of vehicles and especially the sprung weight is reduced, oil consumption of the vehicles can be lowered, the raw material cost, the machining cost and the maintenance cost of brake systems of automobiles, trains and the like can also be reduced, the trafficability of the vehicles is improved, the brake distance is shortened, and the safety of the vehicles is improved.

3. The locally-reinforced light metal matrix composites of the invention can replace existing aluminum MMC which are reinforced only through ceramic, and a ring-mounted piston for a high-power diesel engine can be manufacturing from the locally-reinforced light metal matrix composites by the squeeze casting technique, the operating temperature of the piston can be increased by 50-100° C. while the service life of the original ring-mounted pistons is maintained, in this way, the output power of the diesel engine can be increased, oil consumption is lowered, and exhaust emission is reduced.

4. The locally-reinforced light metal matrix composites of the invention can replace existing homogeneous aluminum alloy materials inlaid with steel bushings, a magnesium alloy load wheel provided with a composites wear-resistant ring made of the wear-resistant material and used for a tracked vehicle can be directly formed through the squeeze casting technique, the weight of the load wheel can be reduced by one third while the wear-resistance and service life of original load wheels are maintained, and vibration and noise of vehicles are reduced.

5. The manufacturing method of the locally-reinforced light metal matrix composites of the invention is high in operability. According to the method, the wear-resistant layer and the light metal alloy matrix metallurgically bond through the squeeze casting technique, light metal alloy liquid infiltrates into the porous preform in the squeeze casting process to form the composites, the wear-resistant layer of the composites then metallurgically bond with the light metal alloy matrix, and thus it is ensured that the wear-resistance and the comprehensive mechanical performance of the locally-reinforced light metal matrix composites meet use requirements.

### BRIEF DESCRIPTION OF THE DRAWINGS

FIG. 1 is a structural diagram of an automotive aluminum alloy brake disc provided with wear-resistant layers in the first embodiment; and

FIG. 2 is a structural diagram of a truck magnesium alloy brake drum provided with a wear-resistant layer in the second embodiment.

### DESCRIPTION OF THE EMBODIMENTS

A further detailed description of the invention is given with accompanying drawings and embodiments as follows.

First Embodiment: an automotive aluminum alloy brake disc provided with wear-resistant layers is manufacturing from cast aluminum alloy designated as A356 in America, wherein the size of the automotive aluminum alloy brake disc is Φ288 mm (outer diameter)*44.6 mm (thickness), and the wear-resistant layers are rings with the size Φ288 mm (outer diameter)*184 mm (inner diameter)*3 mm (thickness). The manufacturing method includes the following steps:

(1) Foam copper with the porosity 10-60 ppm and the thickness 10 mm is machined into a high-temperature resistant skeleton metal with the size Φ288 mm (outer diameter)*184 mm (inner diameter)*10 mm (thickness), and then the high-temperature resistant skeleton metal is placed in a preform mold.

(2) By mass, 10% of alumina fibers, 5% of alumina silicate fibers and 40% of flyash particles, 8% of silicon carbide particles, 3% of the carboxymethylcellulose aqueous solution (with the concentration about 20%) and 12% of the silica sol solution (with the concentration about 50%) are evenly mixed with a proper amount of water to prepare ceramic slurry, the ceramic slurry is then poured into the preform mold in which the high-temperature resistant skeleton metal is installed in advance, the preform mold is vacuumized to 1*10⁻² Pa and then pressurized to 20-30 MPa, a ring with the size Φ288 mm (outer diameter)*184 mm (inner diameter)*10 mm (thickness) is fanned through dewatering and pressing, and the ring is then dried at the temperature 130° C. for 10 h and sintered at the temperature of 850° C. for 3 h, so that a single preform is obtained.

(3) Two single preforms are obtained, connected through six supporting ribs made of foam copper and then placed at specific positions in a squeeze casting mold, A356 aluminum alloy liquid is poured into the squeeze casting mold, mold closing and pressurization are conducted to make the aluminum alloy liquid infiltrate into the porous preforms under pressure till the cavity of the squeeze casting mold is filled with the aluminum alloy liquid, and thus an integrated automotive aluminum alloy brake disc casting with the wear-resistant layers on the upper and lower surfaces is manufacturing.

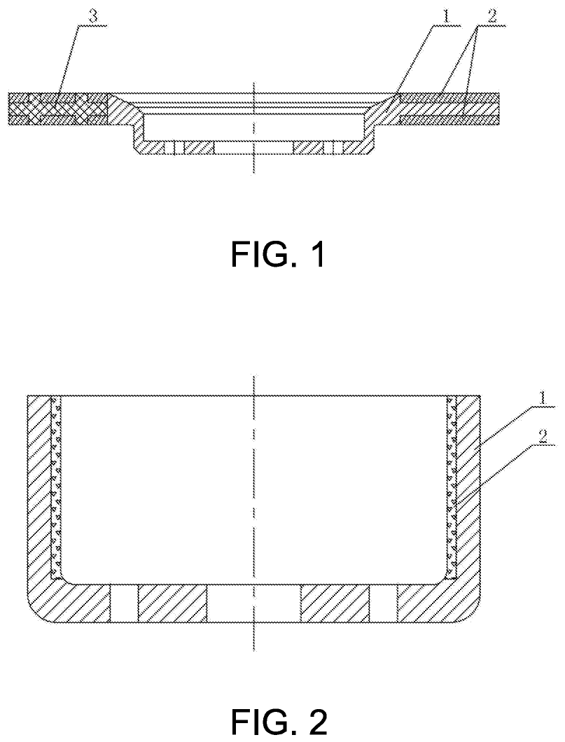

(4) The integrated automotive aluminum alloy brake disc casting is subjected to T6 heat treatment and then machined, so that the automotive aluminum alloy brake disc provided with the wear-resistant layers in the first embodiment is obtained, and FIG. 1 is the structural diagram of the automotive aluminum alloy brake disc provided with the wear-resistant layers. As is shown in FIG. 1, the automotive aluminum alloy brake disc includes an aluminum alloy brake disc body 1, wherein the two working surfaces of the aluminum alloy brake disc body 1 are each attached with one wear-resistant layer 2, the two wear-resistant layers 2 are connected through the six supporting ribs 3, and the six supporting units 3 are arranged at intervals in the circumferential direction of the two wear-resistant layers 2.

Second Embodiment: a truck magnesium alloy brake drum provided with a wear-resistant layer is manufacturing from cast magnesium alloy designated as AZ91D in America, wherein the size of the truck magnesium alloy brake drum is Φ480 mm (outer diameter)*227 mm (height), and the size of the wear-resistant layer is Φ420 mm (outer diameter)*180 mm (height)*7 mm (thickness of the cylindrical wall). The manufacturing method includes the following steps:

(1) By mass, 40% of high-strength steel fibers with the diameter 0.4-1 mm are sorted, woven and spread in a cylindrical preform mold and then compacted, so that a high-temperature resistant skeleton metal is manufacturing and placed at the position close to the inner wall of the preform mold; then 12% of alumina silicate fibers, 41% of silicon carbide particles, 5% of the carboxymethylcellulose aqueous solution (with the concentration about 20%) and 10% of the silica sol solution (with the concentration about 60%) are evenly mixed with a proper amount of water to prepare ceramic slurry, a fixed amount of ceramic slurry is then poured into the preform mold, the preform mold is made to rotate around the central axis, so that the ceramic slurry infiltrates into seams of the fibers under the effect of centrifugal force and part of water is removed, and a cylindrical preform blank with the size Φ420 mm (inner diameter)*180 mm (height) *12 mm (thickness of the cylindrical wall) is obtained.

(2) The cylindrical preform blank with the size Φ420 mm (outer diameter)*180 mm (height)*12 mm (thickness) is then dried at the temperature 100° C. for 15 h and then sintered at the temperature 800° C. for 3 h, so that a finished preform is obtained.

(3) The finished preform is placed at a specific position in the squeeze casting mold, AZ91D magnesium alloy liquid is poured into the squeeze casting mold, mold closing and pressurization are conducted to make the magnesium alloy liquid infiltrate into the porous preform under pressure till the cavity of the squeeze casting mold is filled with the magnesium alloy liquid, and thus a truck magnesium alloy brake drum casting with the wear-resistant layer on the inner wall is manufacturing.

(4) The truck magnesium alloy brake drum casting is subjected to T6 heat treatment and then machined, so that the finished truck magnesium alloy brake drum provided with the wear-resistant layer in the second embodiment is obtained, and FIG. 2 is the structural diagram of the truck magnesium alloy brake drum. As is shown in FIG. 2, the truck magnesium alloy brake drum includes a cylindrical magnesium alloy brake drum body 1, and the inner wall of the magnesium alloy brake drum body 1 is attached with the cylindrical wear-resistant layer 2.

1. A wear-resistant material, comprising high-temperature resistant skeleton metal materials, ceramic fiber materials and ceramic particle materials with the mass ratio of (10-60):(1-30):(10-70); the high-temperature resistant skeleton metal material are foam metal or high-temperature resistant metal fibers; the high-temperature resistant metal fibers comprise one or more of iron-based alloy fibers, nickel-based alloy fibers, copper-based alloy fibers, stainless steel fibers, steel wool fibers, titanium-based alloy fibers and cobalt-based alloy fibers; the ceramic fiber materials comprise one or more of alumina fibers, alumina silicate fibers, silicon dioxide fibers, zirconium oxide fibers, silicon carbide fibers, graphite fibers and carbon fibers; the ceramic particle materials comprise one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles.

2. The wear-resistant material according to claim 1, wherein the ceramic particle materials are mixed with auxiliary reinforcing particles, the auxiliary reinforcing particles are graphite particles and/or steel slag particles; the steel slag particles are one or more of iron oxide particles, zinc oxide particles, calcium oxide particles, magnesium oxide particles, aluminum oxide particles and titanium oxide particles.

3. The wear-resistant material according to claim 1, wherein the foam metal is foam copper, foam iron, foam nickel or foam iron-nickel.

4. The wear-resistant material according to claim 1, wherein the ceramic fiber materials have the diameter of 5-15 μm and the length of 0.8-2.8 mm, the high-temperature resistant metal fibers have the diameter of 0.01-2 mm, the ceramic particle materials have the granularity of 5-200 μm and the Mohs hardness of 5-9, the foam metal has the porosity of 10-60 ppi.

5. A locally-reinforced light metal matrix composites, comprising a light metal alloy matrix and a wear-resistant layer locally attached to the surface of the light metal alloy matrix; the light metal alloy matrix is an aluminum alloy matrix or a magnesium alloy matrix; a composition of the wear-resistant layer comprises high-temperature resistant skeleton metal materials, ceramic fiber materials, ceramic particle materials, a low-temperature binding agent and a high-temperature binding agent with the mass ratio of (10-60):(1-30):(10-70):(0.5-8):(0.5-10); the high-temperature resistant skeleton metal materials are foam metal or high-temperature resistant metal fibers; the high-temperature resistant metal fibers comprise one or more of iron-based alloy fibers, nickel-based alloy fibers, copper-based alloy fibers, stainless steel fibers, steel wool fibers, titanium-based alloy fibers and cobalt-based alloy fibers; the ceramic fiber materials comprise one or more of alumina fibers, alumina silicate fibers, silicon dioxide fibers, zirconium oxide fibers, silicon carbide fibers, graphite fibers and carbon fibers; the ceramic particle materials comprise one or more of flyash particles, superfine slag powder particles, silicon carbide particles, silicon dioxide particles, boron nitride particles, zircon powder particles, brown fused alumina particles, zirconium oxide particles, zirconium silicate particles and chromic oxide particles; the low-temperature binding agent is a carboxymethylcellulose aqueous solution with the concentration of 3-20%, and the high-temperature binding agent is a silica sol solution with the concentration of 10-60%.

6. The locally-reinforced light metal matrix composites according to claim 5, wherein the ceramic particle materials are mixed with auxiliary reinforcing particles, the auxiliary reinforcing particles are graphite particles and/or steel slag particles; the steel slag particles are one or more of iron oxide particles, zinc oxide particles, calcium oxide particles, magnesium oxide particles, aluminum oxide particles and titanium oxide particles.

7. The locally-reinforced light metal matrix composites according to claim 5, wherein the foam metal is foam copper, foam iron, foam nickel or foam iron-nickel.

8. The locally-reinforced light metal matrix composites according to claim 5, wherein the ceramic fiber materials have the diameter of 5-15 μm and the length of 0.8-2.8 mm, the high-temperature resistant metal fibers have the diameter of 0.01-2 mm, the ceramic particle materials have the granularity of 5-200 μm and the Mohs hardness of 5-9, the foam metal has the porosity of 10-60 ppi.

9. A manufacturing method of a locally-reinforced light metal matrix composites comprising the following steps:
by mass fraction, 1-30% of the ceramic fiber materials, 10-70% of the ceramic particle materials, 0.5-8% of the low-temperature binding agent, 0.5-10% of the high-temperature binding agent are added into a proper amount of water to evenly mix to prepare a ceramic slurry;
a fixed amount of the ceramic slurry is poured into a preform mold in which a high-temperature resistant skeleton metal is installed in advance, the pressure is increased to 20-30 MPa, and a semi-finished composites preform is manufacturing through dewatering and pressing;
afterwards, the semi-finished composites preform is dried at the temperature 60-200° C. for 10-20 h and then sintered at the temperature of 700-1000° C. for 2.5-4 h to obtain a finished composites perform; and
finally, the finished composites preform is attached to the light metal alloy matrix which manufacturing in advance by a squeeze casting technique, a wear-resistant layer preform is metallurgically bond with the light metal alloy matrix, and thus the locally-reinforced light metal matrix composites are obtained.

10. The manufacturing method of the locally-reinforced light metal matrix composites according to claim 9, wherein the manufacturing process of the high-temperature resistant skeleton metal is: a foam metal is machined into a sheet matched with the wear-resistant layer in shape and size, and thus the high-temperature resistant skeleton metal is obtained; or high-temperature resistant metal fibers are sorted, processed, woven and evenly spread in a skeleton preform mold and then compacted, and thus the high-temperature resistant skeleton metal is obtained.

11. The manufacturing method of the locally-reinforced light metal matrix composites according to claim 9, wherein the squeeze casting is replaced with environment-friendly sand mold casting, vacuum die casting, centrifugal casting, low pressure casting, differential pressure casting, metal mold casting, investment casting, lost foam casting or vacuum suction casting.
